(19) United States
(12) Patent Application Publication
(10) Pub. No.: US 2025/0310512 A1
(43) Pub. Date: Oct. 2, 2025

(54) ENCODING & DECODING USING GENERATIVE AI FOR COMPRESSION OF VIDEO STREAM WITH DEHAZING CAPABILITIES

(71) Applicant: Oceaneering International, Inc., Houston, TX (US)

(72) Inventors: Sudheendra KRISHNAMURTHY, BENGALURU - 78 (IN); Vemburajan YADAVA, PUNE (IN)

(73) Assignee: Oceaneering International, Inc., Houston, TX (US)

(21) Appl. No.: 19/090,629

(22) Filed: Mar. 26, 2025

(30) Foreign Application Priority Data
Mar. 26, 2024 (IN) 202411023741

(51) Int. Cl. H04N 19/00

(52) U.S. Cl. CPC H04N 19/00

(57) ABSTRACT

A system and method of encoding and decoding using generative AI for compression of video stream uses the system for encoding and decoding using generative AI for compression of video stream that comprises a camera, an encoder comprising generative artificial intelligence (AI) software operative in the encoder to encode video data, a transmitter, a receiver, a processor, a decoder, and a visual display operatively in communication with the decoder. Using the system, video data obtained from the camera are provided to the encoder; the generative artificial intelligence (AI) software encodes the video data at encoder to produce a compressed data set; the compressed data set are transmitted in a kilobit per second range (kbps-range) bandwidth at a low bandwidth using transmitter and receiver and, subsequently, from the receiver to a distant site via a further data network; and the compressed data set decoded at the distant site.

### CROSS-REFERENCE TO RELATED APPLICATIONS

This application claims priority through India Provisional Application IN202411023741 filed on Mar. 26, 2024.

### BACKGROUND OF THE INVENTION

Network bandwidth is limited and at a premium while operating subsea devices from offshore locations. There is a need to produce data, typically video data but the data may comprise other than video data, which are transmitted across a limited bandwidth network data path, typically at least a partially subsea using a kbps-range bandwidth, and subsequently transmitted at a higher bandwidth to, and decoded at, a remote site, e.g., an onshore facility.

### BRIEF DESCRIPTION OF DRAWINGS

Various figures are included herein which illustrate aspects of embodiments of the disclosed inventions.

FIG. 1 is a block diagram of an exemplary system;

FIG. 2 is a flowchart of an exemplary method using Stable Diffusion AI; and

FIG. 3 is a flowchart of an exemplary method in which downstream, preprocessed video data are passed into a reverse engineer backscatter module.

### DETAILED DESCRIPTION OF EMBODIMENTS OF THE INVENTION

The disclosed invention comprises a system for and method of using generative artificial intelligence (AI) to encode data at an offshore location, e.g., subsea, and produce a compressed stream which is transmitted across a kilobits-per-second (kbps) bandwidth network at least partially subsea and, subsequently, transmitted at a higher data rate to be decoded at a remote site, e.g., an onshore facility, for consumption and use. As used herein, “module” means software, with or without specialized hardware to support that software.

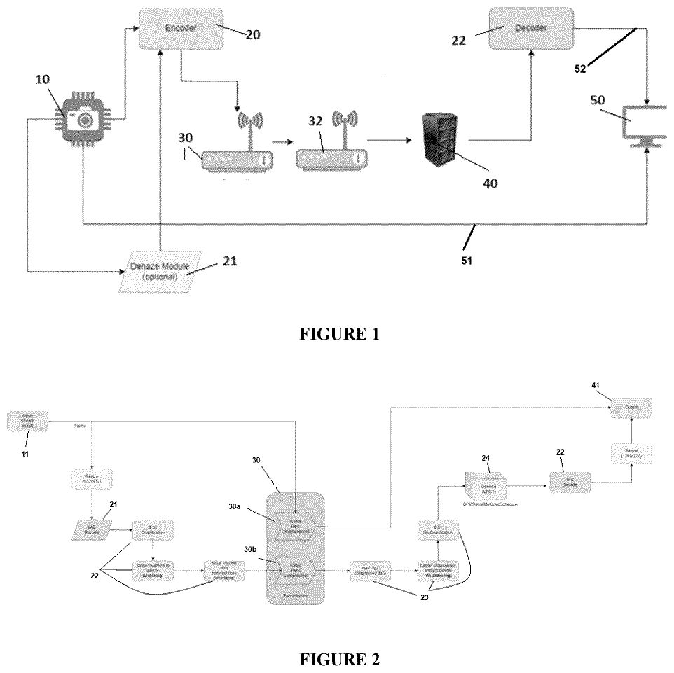

In a first embodiment, referring generally to FIG. 1, system 1 for encoding and decoding using generative AI for compression of video stream comprises camera 10 adapted to be disposed subsea; encoder 20 operatively in communication with camera 10 and configured to compress video data obtained from camera 10 into compressed video data at a rate sufficient to allow the compressed video data to be transmitted over high latency data rates that still support active control of a subsea structure, e.g., a subsea vehicle (such as a remotely operated vehicle (ROV) or an autonomous underwater vehicle (AUV)) or a stationery subsea structure or the like, by a remote controller; transmitter 30 operatively in communication with encoder 20; receiver 32 operatively in communication with transmitter 30; processor 40 operatively in communication with receiver 32; decoder 22 operatively in communication with processor 40; and visual display 50 operatively in communication with decoder 22. Transmitter 30 and receiver 32 are complimentary to each other and each can be a transceiver capable of bidirectional data transmission and reception. Decoder 22 may be disposed proximate to encoder 20 or at a distant location

In embodiments, the stationery structure comprises a blowout preventer (BOP).

Encoder 20 typically comprises generative artificial intelligence (AI) software operative in encoder 20 to encode video data.

In certain embodiments, system 1 further comprises dehazer 21 operatively in communication with camera 10 and encoder 20, where dehazer 21 is operative to process video data from camera 10 into dehazed video and provide the dehazed video to encoder 20.

Camera 10 may be disposed in the subsea vehicle or positioned subsea in or proximate to the subsea structure. Camera 10 and encoder 20 may be co-located or operatively in communication but not co-located.

Encoder 20 is operatively in communication with transmitter 30 via a wired connection, an optical connection, a wireless connection, or a combination thereof

Typically, compression is at least 1000:1 and, more typically, 1090:1 and typically comprises a compression rate up to around 97.39% of space saving.

Receiver 32 may comprise a first acoustic modem that is operational subsea and transmitter 30 may comprise a second acoustic modem operational subsea and configured to transmit data acoustically to receiver 32 subsea.

Typically, data communication between transmitter 30 and receiver 32 is high latency. In embodiments, data from the receiver are provided to processor 40 over a transmission path at low latency data rates, e.g., of up to several gigabits per second. Accordingly, the transmission path may comprise one or more of a wired transmission path, a wireless transmission path, an optical transmission path, an acoustic transmission path, or the like, or a combination thereof.

Processor 40 is typically located proximate receiver 32 or at a distant location where the distant location comprises an onshore location, a surface vessel, or a rig, or the like.

In certain embodiments, video data from camera 10 may be provided directly to visual display 50 via a direct, normal video path 51, directly through video path 52 from decoder 22 after applying decompression steps, or the like, or a combination thereof. Decompression of the video data, while not perfect, is typically still sufficient to for use in providing subsea service, e.g., via a remotely operated vehicle (ROV) or autonomous underwater vehicle (AUV), in the event of full (i.e. normal video stream) video loss or failure of the direct feed video system.

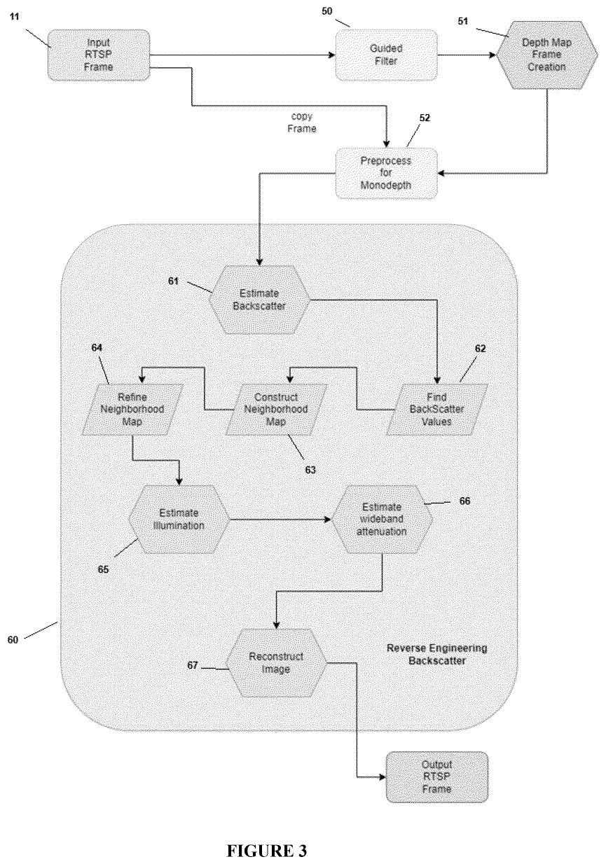

In the operation of exemplary methods, referring still to FIG. 1 and additionally to FIGS. 2-3, encoding and decoding using generative AI for compression of video stream using the system described above comprises a first processing mode which provides video data obtained from 10 camera to encoder 20; using the generative artificial intelligence (AI) software to encode the video data at encoder 20 to produce a compressed data set; transmitting the compressed data set in a kilobit-per-second (“kbps”) range (“kbps-range”) bandwidth at a low bandwidth using transmitter 30 and receiver 32 and subsequently from the receiver to a distant site such as via a further data network; and decoding the compressed data set at the distant site. Typically, the further network comprises a low latency bandwidth operative at a data rate network speed which is greater than the kbps-range bandwidth

Using generative artificial intelligence (AI) software to encode the video data at encoder 20 typically comprises using an encoder module operating in encoder 20 to encode the video data into latent features for use at decoder 22; using software operative in encoder 20 to quantize and convert latent features into dithered palettes for dithering; providing the compressed data set at high latency, relatively low bandwidth in the kbps-range through transmitter 30 to receiver 32 and then on to decoder 22; and processing the compressed data set at decoder 22.

The dithered palettes are typically compressed by compressing bytes in the data into compressed data and returning a bytes object containing the compressed data, thus producing a compressed set of data, e.g., in a data file, at encoder 20.

Processing the compressed data at decoder 22 typically comprises using one or more of a de-palette or an unquantized and denoised module 24 operatively resident in processor 40, decoder 22, or a combination thereof.

As illustrated in FIG. 2, in an exemplary embodiment video stream data 11, defining one or more video frames, are provided to first transmitter 30a for uncompressed transmission at a first data rate to output 41. The video data may also be resized and provided to VAE encoder 21, a variational autoencoder (VAE) comprising a machine learning model that generates new data based on the input data on which it is trained, which, in turn, provides encoded data to various modules, which may comprise quantitizers 22, and to first transmitter 30a and/or a separate second transmitter 30b. If provided to second transmitter 30b, data from second transmitter 30b are typically provided to processing modules 23 to process encoded data and, e.g., unquantitize it, and then to denoise module 24 and decoder 22 before being provided to output 41. Denoise module 24 typically provides noise modelling for the overall processing.

In embodiments, the method further comprises providing processed data, which comprise a generated latent feature, by using a stable diffusion v2.0 VAE decoder to produce final video data. Typically, an encoder module such as Stable Diffusion v2.0's VAE marketed by Stability AI LTD, typically operating in encoder 20, initially encodes video data into latent features for use at decoder 22. As described above, encoder 20 may also further quantize and convert latent features into palettes for dithering. Stable Diffusion v2.0's UNET with DPMSolverMultiStepScheduler for noise modelling may be used for this processing. The processed data generally comprise a generated latent feature which is passed to further processing such as by using a Stable Diffusion v2.0 VAE decoder to produce final video data.

In embodiments, referring to FIG. 3, the video data are passed into guided filter 50, which comprises an edge-preserving smoothing image filter that can filter out noise or texture while retaining sharp edges and depth map data 51 created, and providing original video data along with the depth map data into monodepth data preprocessor 52 to create monodepth data.

In embodiments, a second processing mode may be used which comprises providing preprocessed video data downstream to reverse engineer backscatter module 60 (FIG. 3) which may comprise a set of modules operatively resident in processor 40, decoder 22, or a combination thereof. These modules may themselves comprise estimate backscatter module 61 operative to find a set of data points from which to estimate backscatter by partitioning a video image into different depth ranges and taking a subset of darkest red-green-blue (RGB) triplets from that set as estimations of the backscatter, the subset of darkest RGB triplets comprising a set of backscatter point values; find backscatter values module 62 operative to receive the backspatter and estimate a set of coefficients for a backscatter curve based on the set of backscatter point values and their depths; neighborhood map constructor module 63 operative to receive output from find backscatter values module 62 and construct a neighborhood map from depths and one or more epsilon values; refine neighborhood map module 64 operative to receive data from neighborhood map constructor module 63 and refine the neighborhood map to remove artifacts; estimate illumination module 64 operative to receive data from neighborhood map constructor module 63 and create an estimated illumination map from local color space averaging; wideband attenuation estimation module 66 operative to receive data from estimate illumination module 65 and create an estimate based on beta value; and image reconstruction module 67 operative to receive data from wideband attenuation estimation module 66 and reconstruct an original video image and a globally white balance based a gray world hypothesis. In these embodiments, the first processing mode may be used as a default mode of operation and toggled on or off with respect to the second processing mode, either manually or automatically.

The foregoing disclosure and description of the inventions are illustrative and explanatory. Various changes in the size, shape, and materials, as well as in the details of the illustrative construction and/or an illustrative method may be made without departing from the spirit of the invention.

1. A system for encoding and decoding using generative AI for compression of video stream, comprising:
a) a camera adapted to be disposed subsea;
b) an encoder operatively in communication with the camera and configured to compress video data into compressed video data at a rate sufficient to allow the compressed video data to be transmitted over high latency data rates that still support active control of a subsea structure by a remote controller, the encoder comprising generative artificial intelligence (AI) software operative in the encoder to encode video data;
c) a transmitter operatively in communication with the encoder;
d) a receiver operatively in communication with the transmitter;
e) a processor operatively in communication with the receiver at a low latency data rate;
f) a decoder operatively in communication with the processor; and
g) a visual display operatively in communication with the decoder.

2. The system for encoding and decoding using generative AI for compression of video stream of claim 1, further comprising a dehazer operatively in communication with the camera and with the encoder and operative to process video data from the camera into dehazed video and provide the dehazed video to the encoder.

3. The system for encoding and decoding using generative AI for compression of video stream of claim 1, wherein the subsea structure comprises a subsea vehicle or a stationery subsea structure.

4. The system for encoding and decoding using generative AI for compression of video stream of claim 3, wherein the subsea vehicle comprises a remotely operated vehicle (ROV) or an autonomous underwater vehicle (AUV).

5. The system for encoding and decoding using generative AI for compression of video stream of claim 3, wherein stationery structure comprises a blowout preventer (BOP).

6. The system for encoding and decoding using generative AI for compression of video stream of claim 3, wherein the camera is disposed in the subsea vehicle or positioned subsea in the subsea structure.

7. The system for encoding and decoding using generative AI for compression of video stream of claim 1, wherein the encoder is operatively in communication with the transmitter via a wired connection, an optical connection, a wireless connection, or a combination thereof.

8. The system for encoding and decoding using generative AI for compression of video stream of claim 1, wherein the compression is at least 1000:1

9. The system for encoding and decoding using generative AI for compression of video stream of claim 8, where the compression is 1090:1 with a compression rate up to around 97.39% of space saving.

10. The system for encoding and decoding using generative AI for compression of video stream of claim 1, wherein the camera and the encoder are co-located or operatively in communication but not co-located.

11. The system for encoding and decoding using generative AI for compression of video stream of claim 1, wherein:
a) the receiver comprises a first acoustic modem that is operational subsea; and
b) the transmitter comprises a second acoustic modem operational subsea and configured to transmit data to the receiver subsea.

12. The system for encoding and decoding using generative AI for compression of video stream of claim 1, wherein data communication between the transmitter and the receiver is high latency.

13. The system for encoding and decoding using generative AI for compression of video stream of claim 1, wherein data from the receiver are provided to the processor over a transmission path at low latency data rates of up to several gigabits per second.

14. The system for encoding and decoding using generative AI for compression of video stream of claim 13, wherein the transmission path comprises one or more of a wired transmission path, a wireless transmission path, an optical transmission path, an acoustic transmission path, or a combination thereof.

15. The system for encoding and decoding using generative AI for compression of video stream of claim 1, wherein the processor is located proximate the receiver or at a distant location.

16. The system for encoding and decoding using generative AI for compression of video stream of claim 15, wherein the distant location comprises an onshore location, a surface vessel, or a rig.

17. The system for encoding and decoding using generative AI for compression of video stream of claim 1, wherein video data from the camera are provided directly to the visual display via a direct, normal video path, through a video path from the decoder after applying compression steps, or via both a direct, normal video path and through a video path from the decoder after applying compression steps.
